(19) United States
(12) Patent Application Publication
(10) Pub. No.: US 2024/0406995 A1
(43) Pub. Date: Dec. 5, 2024

(54) MULTIPLE ACCESS POINT NEGOTIATION FOR TRANSMISSION OPPORTUNITY SHARING

(71) Applicant: Samsung Electronics Co., Ltd., Suwon-si (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US); Elliot Jen, Taipei (TW)

(21) Appl. No.: 18/669,401

(22) Filed: May 20, 2024

Related U.S. Application Data
(60) Provisional application No. 63/470,706, filed on Jun. 2, 2023.

(51) Int. Cl. H04W 74/0808

(52) U.S. Cl. CPC H04W 74/0808

(57) ABSTRACT

A first access point (AP) in a wireless network, the first AP comprising a memory and a processor coupled to the memory, the processor configured to: transmit a request frame requesting a transmission opportunity (TXOP) sharing to a plurality of APs including a second AP, wherein the request frame comprises a set of parameters for the TXOP sharing, and receive a response frame from the second AP indicating the second AP accepts the TXOP sharing request.

### CROSS-REFERENCE TO RELATED APPLICATIONS

This application claims the benefit of priority from U.S. Provisional Application No. 63/470,706, entitled “Multiple Access Point (MAP) Negotiation Procedure for TXOP Sharing” filed Jun. 2, 2023, which is incorporated herein by reference in its entirety.

### TECHNICAL FIELD

This disclosure relates generally to a wireless communication system, and more particularly to, for example, but not limited to, transmission opportunity (TXOP) sharing procedures in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a first access point (AP) in a wireless network. The first AP comprising a memory and a processor coupled to the memory. The processor is configured to transmit a request frame requesting a transmission opportunity (TXOP) sharing to a plurality of APs including a second AP, wherein the request frame comprises a set of parameters for the TXOP sharing. The processor is configured to receive a response frame from the second AP indicating the second AP accepts the TXOP sharing request.

In some embodiments, the processor is further configured to: prior to transmitting the request frame, transmitting an announcement frame to the plurality of APs indicating an intention to initiate a multi-AP coordination; and receive a preparedness frame from the second AP indicating capabilities to participate in the multi-AP coordination.

In some embodiments, processor is further configured to receive a response frame from a third AP indicating that the third AP rejects the TXOP sharing request

In some embodiments, the processor is further configured to: receive a response frame from a third AP including an alternative set of parameters for the TXOP sharing; and transmit another request frame to the third AP with the alternative set of parameters so that AP3 can participate in the TXOP sharing.

In some embodiments, the set of parameters specify rules regarding sharing the TXOP with other stations (STAs).

In some embodiments, the set of parameters including peer-to-peer (P2P) information related to the P2P stations (STAs) in a Basic Service Set (BSS) managed by the first AP.

In some embodiments, the set of parameters including P2P information related to the P2P STAs in a BSS managed by the second AP.

In some embodiments, the set of parameters include timing information on a portion of the TXOP that is allocated to the second AP.

In some embodiments, the set of parameters include channel information indicating a set of channels that the second AP is allowed to use.

In some embodiments, the set of parameters include operating class information indicating a set of operating classes that the second AP is allowed to use.

One aspect of the present disclosure provides a first access point (AP) that serves as a central controller to coordinate transmission opportunity (TXOP) sharing in a wireless network. The first AP comprises a memory and a processor coupled to the memory. The processor is configured to receive a request frame requesting a transmission opportunity (TXOP) sharing from a second AP. The processor is configured to transmit a response frame to the second AP accepting the request for TXOP sharing request. The processor is configured to transmit a frame to a plurality of APs, including a third AP, with a set of parameters for the TXOP sharing. The processor is configured to receive an acknowledgement frame from the third AP.

In some embodiments, the processor is further configured to: prior to receiving the request frame, transmitting an announcement frame to the plurality of APs indicating an intention to initiate a multi-AP coordination; and receive a preparedness frame from the third AP indicating capabilities to participate in the multi-AP coordination.

In some embodiments, the processor is further configured to receive a response frame from a fourth AP indicating that the fourth AP rejects the TXOP sharing request.

In some embodiments, the processor is further configured to: receive a response frame from a fourth AP including an alternative set of parameters for the TXOP sharing; and transmit another request frame to the fourth AP with the alternative set of parameters so that AP3 can participate in the TXOP sharing.

In some embodiments, the set of parameters specify rules regarding sharing the TXOP with other stations (STAs).

In some embodiments, the set of parameters including peer-to-peer (P2P) information related to the P2P stations (STAs) in a Basic Service Set (BSS) managed by the second AP.

In some embodiments, the set of parameters including P2P information related to the P2P STAs in a BSS managed by the third AP.

In some embodiments, the set of parameters include timing information on a portion of the TXOP that is allocated to the third AP.

In some embodiments, the set of parameters include channel information indicating a set of channels that the third AP is allowed to use.

In some embodiments, the parameters include operating class information indicating a set of operating classes that the third AP is allowed to use.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates Mode 1 operation of transmission opportunity (TXOP) sharing in accordance with an embodiment.

FIG. 5 illustrates Mode 2 operation for both UL/DL and P2P communication in accordance with an embodiment.

FIG. 6 illustrates a type-I architecture for MAP TXOP sharing coordination in accordance with an embodiment.

FIG. 7 illustrates an example of a frame exchange for MAP TXS coordination of a type-I architecture in accordance with an embodiment.

FIG. 8 illustrates an example of a negotiation for TXS coordination in accordance with an embodiment.

FIG. 9 illustrates a flow chart of an example process of TXS based MAP negotiation for a type-I architecture in accordance with an embodiment.

FIG. 10 illustrates a type-II architecture for coordinated TXS negotiation in accordance with an embodiment.

FIG. 11 illustrates an example communication between APs and a central controller for TXS negotiation in accordance with an embodiment.

FIG. 12 illustrates a flow chart of an example process for MAP TXS negotiation of a type-II architecture in accordance with an embodiment.

FIG. 13 illustrates a multiuser request-to-send (MU-RTS) TXOP sharing (TXS) frame format in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

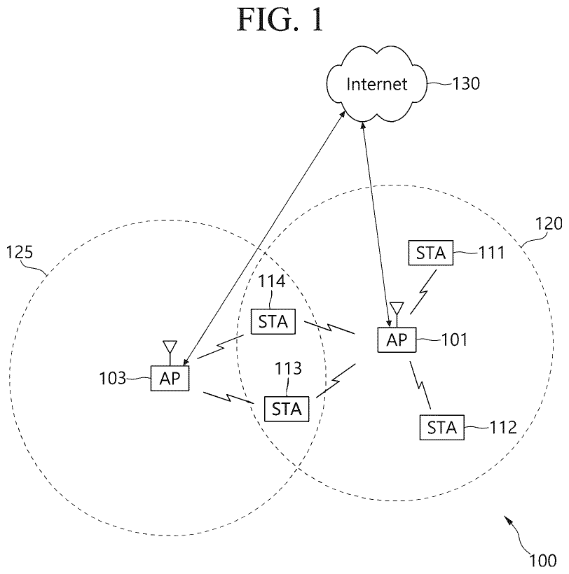

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

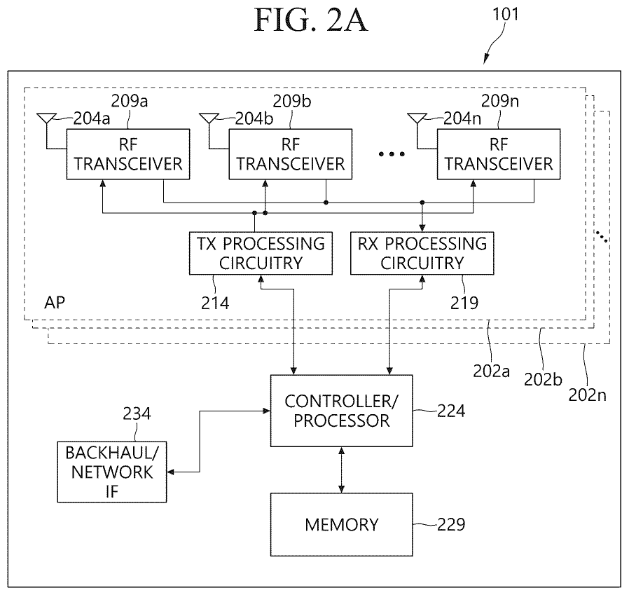

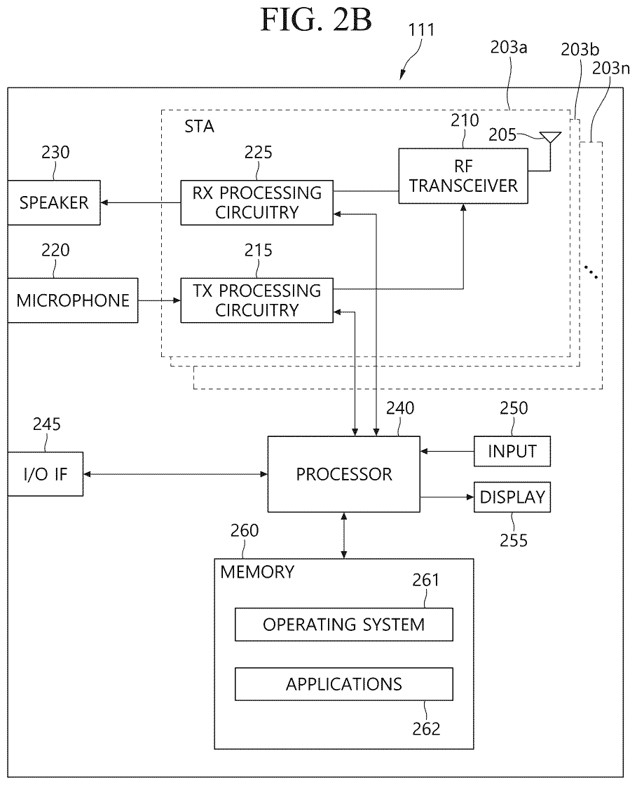

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

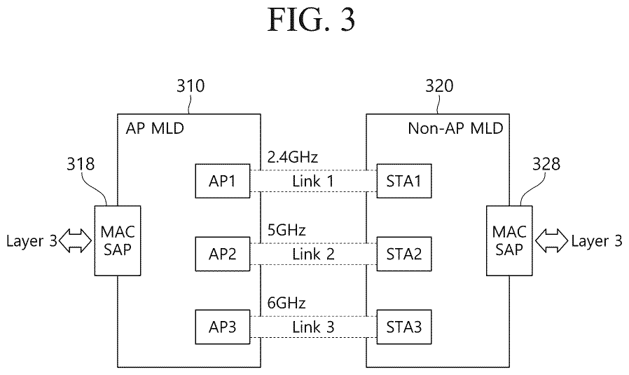

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications” and ii) IEEE P802.11be/D3.0, “Wireless LAN Medium Access Control (MAC) and Physical Layer (PHY) Specifications.”

Triggered TXOP Sharing (TXS) is a feature in IEEE 802.11be. Using the TXOP sharing procedure, an AP may help an STA to obtain the channel so that the STA can deliver its packets. TXOP sharing procedure may include the following five steps. In step 1, an AP may first obtain the channel, whereby the AP may obtain the TXOP for the wireless medium. In step 2, the AP may decide to allocate a portion of its obtained TXOP to a particular STA, for example STA1, in its BSS. In step 3, the AP may make some indications to STA1 that informs STA1 about the allocated TXOP. In step 4, the STA1 utilizes the allocated TXOP for its uplink or peer-to-peer (P2P) communication. In step 5, the STA1 returns the TXOP to the AP after utilizing its allocated TXOP. The AP may indicate to an STA about the STA's allocated TXOP by using a multi-user request-to-send (MU-RTS) TXS frame, which is a trigger frame introduced in IEEE 802.11be. Currently, one MU-RTS TXS Trigger frame can allocate TXOP to a single STA only, and not more than one STAs.

There are two TXOP sharing modes, which include Mode 1 that is used only for uplink/downlink (UL/DL) communication and Mode 2 which may be used for both UL/DL and peer to peer (P2P) communication.

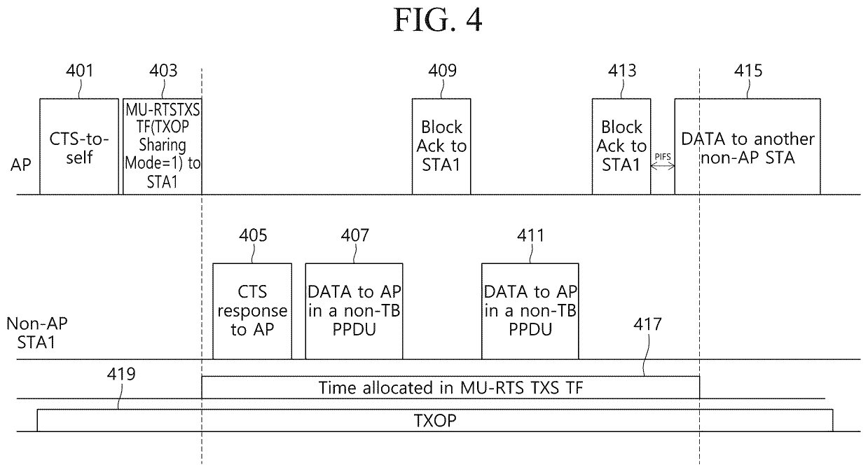

FIG. 4 illustrates Mode 1 operation of TXOP sharing in accordance with an embodiment. In the Mode 1 (UL/DL communication), the AP allocates the TXOP to a STA, illustrated as non-AP STA1, and indicates to the STA1 that the STA 1 can use this TXOP 419 only to transmit uplink data packets.

In some embodiments, AP transmits a clear to send (CTS)-to-self frame 401. A CTS-to-self frame is a CTS frame in which the receiver address (RA) field is equal to the transmitter's MAC address. Then, AP transmits a MU-RTS TXS trigger frame (TF) (TXOP Sharing Mode=1) 403 to STA 1. AP allocates a portion of time 417 of the TXOP 419 to STA1 in the MU-RTS TXS TF 403. Accordingly, during the allocated portion of time 417, STA 1 exchanges frames with AP. For instance, STA1 transmits a CTS response frame 405 to AP. Subsequently, STA 1 transmits data in a non-Trigger Based Physical Layer Protocol Data Unit (non-TB PPDU) 407 to AP. The AP transmits a Block Ack 409 to STA1. STA1 transmits another data in non-TB PPDU 411 to AP and the AP transmits a Block Ack 413 to STA1. Then, after Point Coordination Function Interframe Space (PIFS) 421, AP transmits data 415 to another non-AP STA.

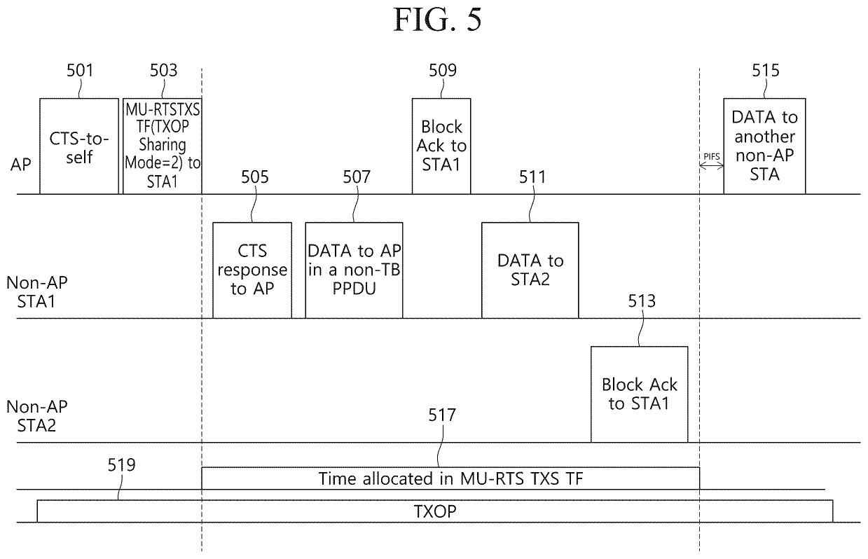

FIG. 5 illustrates Mode 2 operation for both UL/DL and P2P communication in accordance with an embodiment. In Mode 2, the AP allocates a portion of the TXOP to a STA and indicates to the STA that the STA can use the allocated TXOP for both uplink communication and P2P communication. As illustrated in FIG. 5, the STA1 uses the allocated TXOP from the AP for both uplink communication with the AP and P2P communication with STA2.

Referring to FIG. 5, AP transmits a CTS-to-self frame 501. In some embodiments, a CTS-to-self frame may allow an AP to obtain channel access protection, which may provide a lower overhead than a full request-to-send (RTS)/CTS exchange. Accordingly, AP transmits a MU-RTS TXS TF (TXOP Sharing Mode=2) 503 to STA 1. During TXOP 519, there is a portion of the TXOP time allocated for STA1, indicated as Time allocated in MU-RTS TXS TF 517. During the allocated time, STA1 transmits a CTS response 505 to the AP. STA1 transmits data in a non-TB PPDU 507 to the AP. The AP transmits a Block Ack 509 to the STA1. Subsequently, STA1 transmits data 511 to STA2. STA2 transmits a Block Ack 513 to STA 1. Then, after a PIFS 521, AP transmits data 515 to another non-AP STA.

Accordingly, in the two TXOP sharing modes, only the access point (AP), can share the obtained TXOP with a non-AP STA after obtaining the TXOP to the wireless medium through contention.

Interference from one BSS may often cause performance issues for STAs and APs in neighboring BSSs. This may naturally result in overall throughput degradation in the network. The Overlapping BSS (OBSS) interference may also increase an overall latency since it may take more time to access a channel due to the interference occupying the channel. If a STA in a BSS has latency-sensitive traffic, this delay in channel access can degrade the performance of the STA's latency-sensitive applications.

Sharing a TXOP obtained by a first AP with a second AP can help a latency-sensitive application in the BSS managed by the second AP. Accordingly, embodiments in accordance with this disclosure may allow two APs to share their obtained TXOPs with each other. Some embodiments may include a negotiation procedure that may take place between two or more APs for TXOP sharing.

In some embodiments, a first AP can coordinate with a second AP in the vicinity of the first AP in order to share a TXOP obtained by the first AP with the second AP, which may be referred to as coordinated TXOP sharing. A coordination mechanism can take different formats based on the architecture of the Multi-AP (MAP) TXOP sharing.

Different types of MAP TXOP sharing architectures are described below, including type-I architectures where APs can directly exchange frames with other APs to perform MAP TXOP coordination and type-II architectures where APs may communicate with a central controller to perform MAP TXOP coordination.

In particular, in a type-I architecture of MAP TXOP sharing coordination, the APs participating in the MAP TXOP sharing coordination can directly exchange frames with other APs to negotiate the MAP TXOP coordination. In some embodiments, the negotiation can take place in order for the APs to agree on a set of parameters related to the TXOP sharing among the APs. In certain embodiments, a negotiation can take place in order for the APs to agree on a procedure for TXOP sharing among the multiple APs.

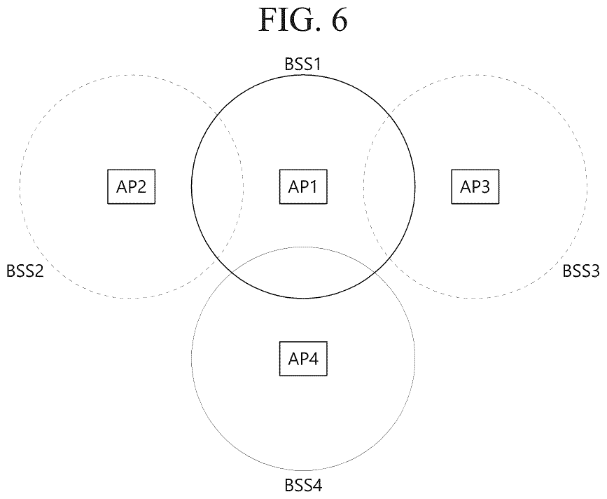

FIG. 6 illustrates a type-I architecture for MAP TXOP sharing coordination in accordance with an embodiment. In particular, FIG. 6 illustrates a network topology with four APs, including AP1, AP2, AP3, and AP4, and the corresponding BSS, including BSS1, BSS2, BSS3, and BSS4, for each of the APs. As illustrated, there can be overlap between the different BSSs, in particular, BSS1 overlaps with BSS2, BSS3 and BSS4.

In some embodiments, based on the type-I architecture for coordinated TXOP sharing, a first AP that intends to participate in a MAP TXOP sharing can send a coordinated TXS (C-TXS) request frame to a second AP in its vicinity in order to request MAP TXOP sharing coordination. In some embodiments, transmitting the C-TXS request frame may initiate a negotiation for the MAP TXOP sharing coordination. The C-TXS request frame may include information related to TXOP parameters and procedures of TXOP sharing among multiple APs. Table 1 below provides a format for a C-TXS request frame in accordance with an embodiment.

TABLE 1

| Order | Information |
|---|---|
| 1 | Category |
| 2 | Unprotected S1G Action |
| 3 | Dialog Token |
| 4 | TXOP Sharing Coordination Mode |
| 5 | Zero or more QoS Characteristics element |
| 6 | P2P Information |
| 7 | SCS Information |
| 8 | Resource Information |

The various fields in table 1 are now described. In particular, in table 1, a Category field may indicate a frame type. The Unprotected SIG Action field may differentiate an action frame format. The Dialog Token field may be a unique identifier for frame exchanges.

In table 1, a TXOP Sharing Coordination Mode field may indicate different modes of TXOP sharing procedure. When a first AP allocates a TXOP to a second AP for operation in a BSS managed by the second AP, a particular mode from several modes may be indicated in the TXOP Sharing Coordination Mode field. The different modes can include the following modes described below.

Mode-1: In this mode of operation, the second AP may be allowed to further allocate its received TXOP to another STA.

Mode-2: In this mode of operation, the second AP may be allowed to utilize the allocated TXOP for downlink transmission.

Mode-3: In this mode of operation, the second AP may be allowed to utilize the received TXOP for triggering uplink transmission from another STA in the second AP's BSS.

Mode-4: In this mode of operation, the second AP may be allowed to utilize the received TXOP for triggering another STA that is associated with the second AP for peer-to-peer (P2P) transmission with another STA.

Mode-5: In this mode of operation, the second AP may be allowed to utilize the received TXOP for triggering another STA that is not associated with the second AP. Such triggering may trigger the STA for using the TXOP for the STA's P2P communication.

Mode-6: In this mode of operation, the second AP may be allowed to use the TXOP by using the channels that are indicated by the trigger frame.

Mode-7: In this mode of operation, the second AP may be allowed to use the TXOP by using any channel that may or may not be within the recommended set of channels as indicated in the trigger frame.

Mode-8: In this mode of operation, the second AP may be allowed to use the TXOP for transmitting the physical layer protocol data units (PPDUs) that correspond to a set of traffic identifier (TIDs) that are indicated in the trigger frame.

Mode-9: In this mode of operation, the second AP may be allowed to use the TXOP for transmitting the PPDUs that may not correspond to a set of TIDs that are indicated in the trigger frame.

Mode-10: In this mode of operation, the second AP may be allowed to use the TXOP for transmission of latency-sensitive traffic in the second AP's BSS.

Mode-11: In this mode of operation, the second AP may be allowed to use the TXOP for both latency-sensitive and latency-tolerant traffic.

Mode-12: In this mode of operation, the second AP may be allowed to use the TXOP for transmission during a transmission (TXS) scheduled period (SP) (or any TXS SP).

Mode-13: In this mode of operation, the second AP may be allowed to use the TXOP for transmission with a power that is below a certain threshold. The threshold may be indicated in the trigger frame.

Mode-14: In this mode of operation, the second AP may be allowed to use the TXOP for transmission with a certain set of enhanced distributed channel access (EDCA) parameters.

Mode-15: In this mode of operation, the second AP may be allowed to use the TXOP for transmission using a certain set of operating classes as indicated by the first AP.

Mode-16: In this mode of operation, the second AP may be allowed to use the TXOP for transmission using an operating class that may or may not be with a set of operating classes that is indicated by the first AP.

In table 1, the Zero or more QoS Characteristics element field may include a set of parameters that define the characteristics and QoS expectations of a traffic flow.

In table 1, the P2P Information field may indicate information related to the peer-to-peer (P2P) STAs present in a BSS managed by the AP that sends the C-TXS request frame. In some embodiments, when a first AP sends a C-TXS request frame to a second AP, the P2P Information field in the C-TXS request frame may include one or more of information described in items 1-8 below.

1. The number of P2P STAs that are present in the BSS managed by the first AP.

2. The number of P2P STAs that are present in the BSS managed by the first AP and that are associated with the first AP.

3. The number of P2P STAs that are present in the BSS managed by the first AP and are not associated with the first AP.

4. The association identifiers (AIDs) of the P2P STAs that are present in the BSS managed by the first AP.

5. The association identifiers (AIDs) of the P2P STAs that are present in the BSS managed by the first AP and are associated with the first AP.

6. The association identifiers (AIDs) of the P2P STAs that are present in the BSS managed by the first AP and are not associated with the first AP.

7. The quality of service (QOS) information of the P2P STAs that are present in the BSS managed by the first AP.

8. Any other information related to the P2P STAs that are present in the BSS managed by the first AP (for example, types of P2P STAs such as TDLS, Wi-Fi Direct, Wi-Fi Aware, among others).

In table 1, the P2P Information field can indicate information related to the peer-to-peer STAs present in a BSS managed by the AP that receives the C-TXS request frame. In some embodiments, when a first AP sends a C-TXS request frame to a second AP, the P2P Information field in the C-TXS request frame includes information from one or more of items 1-4 below.

1. The number of P2P STAs present in the BSS managed by the second AP that can use a TXOP shared by the first AP to the second AP.

2. The association identifiers (AIDs) of the P2P STAs present in the BSS managed by the second AP that can use a TXOP shared by the first AP to the second AP.

3. The types of P2P STAs present in the second AP's BSS that can use a TXOP shared by the first AP to the second AP.

4. Any other information related to the P2P STAs present in the BSS managed by the second AP that can use a TXOP shared by the first AP to the second AP.

In table 1, the SCS Information field may include information related to an SCS procedure that can be used during the TXOP shared among the APs.

In table 1, the Resource Information field may indicate different resources that can be used for the TXOP that is shared between a first AP and a second AP. When a first AP sends a C-TXS request frame to a second AP, the Resource Information field include one or more of information items 1-6 described below.

1. The timing information on when the first AP intends to allocate a portion of its TXOP to the second AP.

2. The timing information on what portion of the AP's TXOP will be allocated to a second AP.

3. The channel information which may include the set of channels that the second AP can use to utilize a TXOP (either to transmit using the allocated TXOP or further relay the allocated TXOP to other STAs that are in the BSS managed by the second AP) that is allocated to the second AP by the first AP.

4. The operating classes which may include the set operating classes that the second AP can use to utilize a TXOP (either to transmit using the allocated TXOP or further relay the allocated TXOP to other STAs that are in the BSS managed by the second AP) that is allocated to the second AP by the first AP.

5. The power information which may include the maximum transmit power the second AP can use for utilizing the TXOP that is allocated to the second AP by the first AP. In some embodiments, the power information may indicate the maximum transmit power the second AP can use to transmit using the TXOP allocated to the second AP by the first AP. In some embodiments, in the case of the second AP, upon receiving the TXOP from the first AP, further relays the TXOP to another STA in the BSS managed by the second AP, the power information can indicate the maximum transmit power that other STAs can use during that TXOP.

6. The information on the spatial direction that can be used for transmission during the TXOP that is allocated to the second AP by the first AP.

In some embodiments, the second AP, after receiving the C-TXS request frame from the first AP can send a C-TXS response frame to the first AP indicating a response to the received C-TXS request. If the second AP indicates acceptance of the C-TXS request, then the first AP and the second AP may become members of an MAP TXOP sharing (TXS) coordination set. A format of a C-TXS Response frame is shown in table 2.

TABLE 2

| Order | Information |
|---|---|
| 1 | Category |
| 2 | Unprotected S1G Action |
| 3 | Dialog Token |
| 4 | TXOP Sharing Coordination Mode |
| 5 | Zero or more QoS Characteristics element |
| 6 | P2P Information |
| 7 | SCS Information |
| 8 | Resource Information |
| 9 | Response Code |

In table 2, the various fields, including the usage of the TXOP Sharing Coordination Mode field, QOS Characteristics IE field, P2P Information field, SCS Information field, and Resource Information field in the C-TXS Response frame can be the same or similar to that included in the C-TXS request frame.

The Response Code in the C-TXS response frame can indicate the response of an AP that receives the C-TXS request frame. Table 3 provides an encoding of the response code in accordance with an embodiment.

TABLE 3

| Order | Information |
|---|---|
| 1 | Accept: The responder AP accepts the TXOP sharing |
| | request received from the requester AP. |
| | This may indicate that the responder AP accepts the TXOP |
| | sharing procedure with all the parameters that the requester |
| | AP has included in the C-TXS Request frame that is transmitted |
| | to the responder AP by the requester AP. |
| 2 | Reject: The responder AP rejects the TXOP sharing |
| | request received from the requester AP. |
| 3 | Alternate: The responder AP rejects the TXOP sharing |
| | request received from the requester AP, however also |
| | indicates that if the requester AP changes one or more |
| | of the TXOP sharing parameters and re-sends the request, |
| | the responder AP might accept the request. |
| 4 | Suggest: The responder AP rejects the TXOP sharing |
| | request received from the requester AP, and suggests |
| | some new parameters related to the TXOP sharing |
| | coordination. If the requester AP sends another |
| | request with the suggested parameters, then the |
| | requester AP will accept the request |

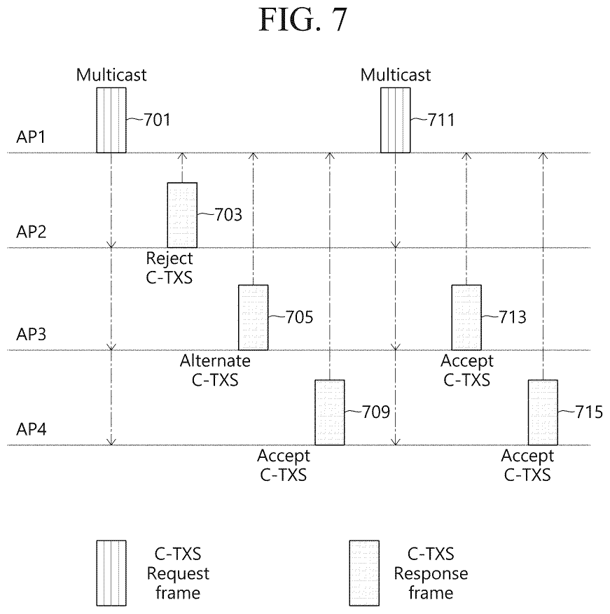

FIG. 7 illustrates an example of a frame exchange for MAP TXS coordination of a type-I architecture in accordance with an embodiment. In particular, FIG. 7 illustrates communication between 4 APs, including AP1, AP2, AP3 and AP4.

In FIG. 7, AP1 sends a multicast C-TXS request frame 701 to AP2, AP3, and AP4. AP2 responds with a C-TXS response frame 703 that indicates that AP2 rejects the TXOP sharing coordination request. AP3 may not be capable of supporting the TXOP sharing coordination with all the parameters listed in the C-TXS request frame 701, but can support can support with some alternative set of parameters. Accordingly, AP3 sends a C-TXS response frame 705 to AP1 which includes the alternative set of parameters in the response frame. AP4 transmits a C-TXS response frame 709 to AP1 that indicates that AP4 accepts the C-TXS request from AP1 and also indicates that AP4 also supports other sets of parameters for TXOP sharing. Subsequently, AP1 sends another C-TXS request frame 711 to AP3 and AP4 with a new set of parameters so that both AP3 and AP4 can participate in the TXOP sharing coordination. In response, AP3 and AP4 each transmit a C-TXS response frame 713 and 715 to AP1 indicating that AP3 and AP4 accept the C-TXS. With this, AP1, AP3 and AP4 form a TXOP sharing multi-AP coordination set.

In some embodiments, for a type-I architecture for coordinated TXS negotiation, an announcement phase may precede active negotiation between APs. In some embodiments, a first AP that intends to initiate TXS MAP coordination with other APs may first transmit a C-TXS announcement frame to identify the APs in its neighborhood that are willing to participate in TXS MAP coordination. Upon receiving the C-TXS announcement frame from the first AP, the second AP may send a C-TXS preparedness frame to the first AP indicating its capability to participate in the TXS MAP coordination. In the C-TXS preparedness frame, AP2 may also indicate the parameters for coordination that the AP2 supports in AP′2 BSS.

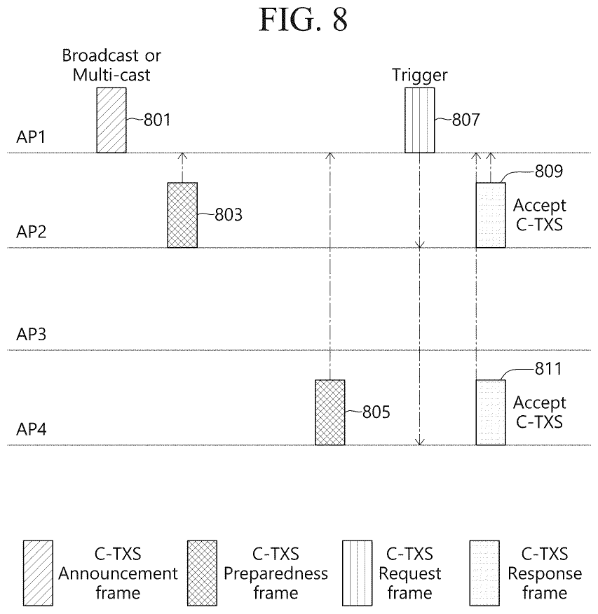

FIG. 8 illustrates an example of a negotiation for TXS coordination in accordance with an embodiment. In FIG. 8, the C-TXS negotiation phase is preceded by a coordinated TXS announcement phase by an AP. In particular, FIG. 8 illustrates communication amongst four APs, including AP1, AP2, AP3, and AP4. AP1 transmits a broadcast or multi-cast frame C-TXS announcement frame 801. AP2 and AP4 each respond by transmitting a C-TXS preparedness frame 803 and 805 to AP1. Subsequently, AP1 transmits a C-TXS request frame 807 to AP2 and AP4. Subsequently, AP2 and AP4 each transmit a C-TXS response frame 809 and 811 that indicates acceptance of the C-TXS.

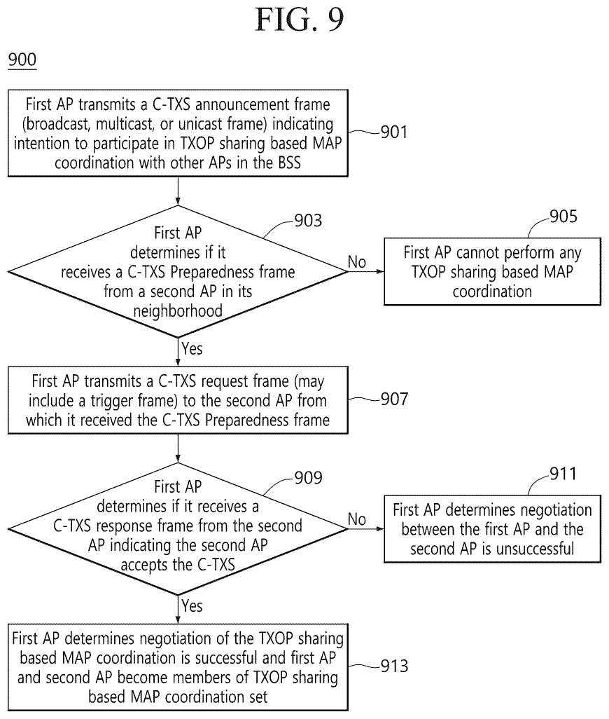

FIG. 9 illustrates a flow chart of an example process of TXS based MAP negotiation for a type-I architecture in accordance with an embodiment. For explanatory and illustration purposes, the example process 900 may be performed by the AP depicted in FIGS. 1 and 3. Although one or more operations are described or shown in particular sequential order, in other embodiments the operations may be rearranged in a different order, which may include performance of multiple operations in at least partially overlapping time periods.

In operation 901, the first AP transmits a C-TXS announcement frame (e.g., broadcast, multicast, or unicast frame) indicating an intention to participate in TXOP sharing based MAP coordination with other APs in the BSS.

In operation 903, the first AP determines whether it receives a C-TXS preparedness frame from a second AP in the first AP's neighborhood. If the first AP determines that it does not receive the C-TXS preparedness frame, in operation 905, the first AP determines that cannot perform any TXOP sharing based MAP coordination.

If the first AP determines that it does receive the C-TXS preparedness frame, in operation 907, the first AP transmits a C-TXS request frame, which may be a trigger frame, to the second AP from which it received the C-TXS preparedness frame.

In operation 909, the first AP determines if it receives a C-TXS response frame from the second AP indicating the second AP accepts the C-TXS.

If the first AP determines that it does not receive the C-TXS response frame from the second AP indicating that the second AP accepts the C-TXS, in operation 911, the first AP determines that the negotiation between the first AP and the second AP is unsuccessful.

If the first AP determines that it does receive the C-TXS response frame from the second AP indicating that the second AP accepts the C-TXS, in operation 913, the first AP determines negotiation of the TXOP sharing based MAP coordination is successful and first AP and second AP become members of TXOP sharing based MAP coordination set.

Table 4 provides a possible format of a C-TXS announcement frame in accordance with an embodiment. The fields can be the same or similar to that included in the C-TXS request frame.

TABLE 4

| Order | Information |
|---|---|
| 1 | Category |
| 2 | Unprotected S1G Action |
| 3 | Dialog Token |
| 4 | TXOP Sharing Coordination Mode |
| 5 | Zero or more QoS Characteristics element |
| 6 | P2P Information |
| 7 | SCS Information |
| 8 | Resource Information |
| 9 | Response Code |

Table 5 provides a possible format of a C-TXS preparedness frame in accordance with an embodiment. The fields can be the same or similar to that included in the C-TXS request frame.

TABLE 5

| Order | Information |
|---|---|
| 1 | Category |
| 2 | Unprotected S1G Action |
| 3 | Dialog Token |
| 4 | TXOP Sharing Coordination Mode |
| 5 | Zero or more QoS Characteristics element |
| 6 | P2P Information |
| 7 | SCS Information |
| 8 | Resource Information |
| 9 | Response Code |

In some embodiments, in a type-II architecture of coordinated TXS (C-TXS) negotiation, the TXOP sharing (TXS) negotiations may be controlled by a TXS central controller. In some embodiments, different types of TXS MAP negotiations may be performed through the central controller.

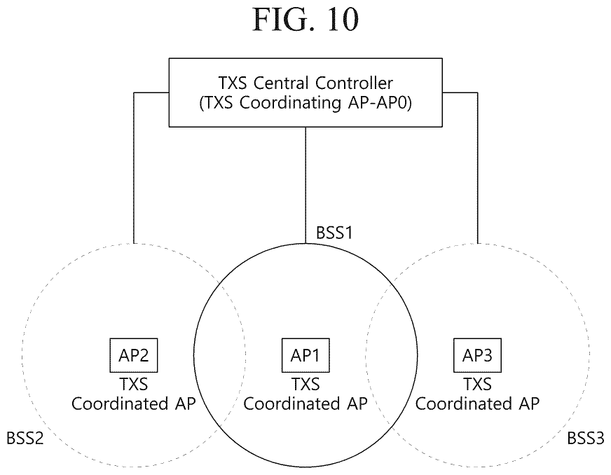

FIG. 10 illustrates a type-II architecture for coordinated TXS negotiation in accordance with an embodiment. In particular, FIG. 10 illustrates several APs, including AP1, AP2, and AP3 and a TXS Central Controller. The TXS Central Controller may be a TXS coordinating AP, AP0, and each of AP1, AP2, and AP3 may be a TXS coordinated AP. As illustrated, each AP includes a BSS, including BSS1, BSS2, and BSS3, with BSS1 overlapping BSS2 and BSS3. Furthermore, each AP is communicating with the TXS Central Controller.

In some embodiments, in a type-II architecture for coordinated TXS negotiation, a first AP that intends to initiate the multi-AP coordination with other APs may first send a request frame (e.g., C-TXS request frame) to a TXS central controller. The TXS central controller may have the parameters related to the TXOP sharing from one or more other APs that are connected with the controller. Upon receiving the request frame from the first AP, the central controller can send a response frame to the first AP based on the overall network situation. If the central controller accepts the coordination request, then the central controller can send a TXS coordination information frame with coordination information to other APs which the controller may determine are suitable for coordination. Accordingly, the transmission of the TXS coordination information frame from the central controller may trigger the APs to participate in the TXS coordination initiated by the first AP. Subsequently, the APs that receive the TXS coordination information frame from the central controller can send a TXS coordination acknowledgement frame to the central controller as an acknowledgement for the reception.

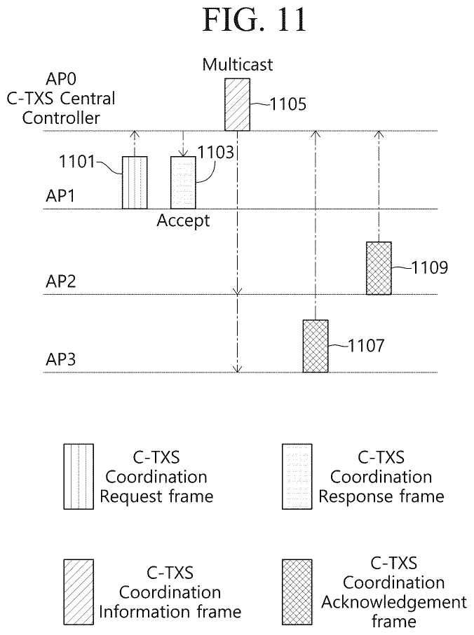

FIG. 11 illustrates an example communication between APs and a central controller for TXS negotiation in accordance with an embodiment. In particular, FIG. 11 illustrates frame exchange amongst a C-TXS central controller, AP0, and several APs, including AP1, AP2, and AP3. Initially, AP1 transmits a C-TXS coordination request frame 1101 to the C-TXS central controller. Subsequently, the C-TXS central controller transmits a C-TXS coordination response frame 1103 that indicates that the C-TXS central controller accepts the request from AP1. Then, the C-TXS central controller transmits a multicast C-TXS coordination information frame to AP2 and AP3. AP3 transmits a C-TXS acknowledgement frame 1107 to the C-TXS central controller. AP2 also transmits a C-TXS acknowledgement frame 1109 to the C-TXS central controller.

In some embodiments, the format of the TXS coordination request frame, and the TXS coordination response frame can be the same as that of C-TXS request frame and C-TXS announcement frame.

Table 6 provides a possible format of a TXS coordination information frame in accordance with an embodiment. The fields can be the same or similar to that included in the C-TXS request frame.

TABLE 6

| Order | Information |
|---|---|
| 1 | Category |
| 2 | Unprotected S1G Action |
| 3 | Dialog Token |
| 4 | TXOP Sharing Coordination Mode |
| 5 | Zero or more QoS Characteristics element |
| 6 | P2P Information |
| 7 | SCS Information |
| 8 | Resource Information |
| 9 | Response Code |

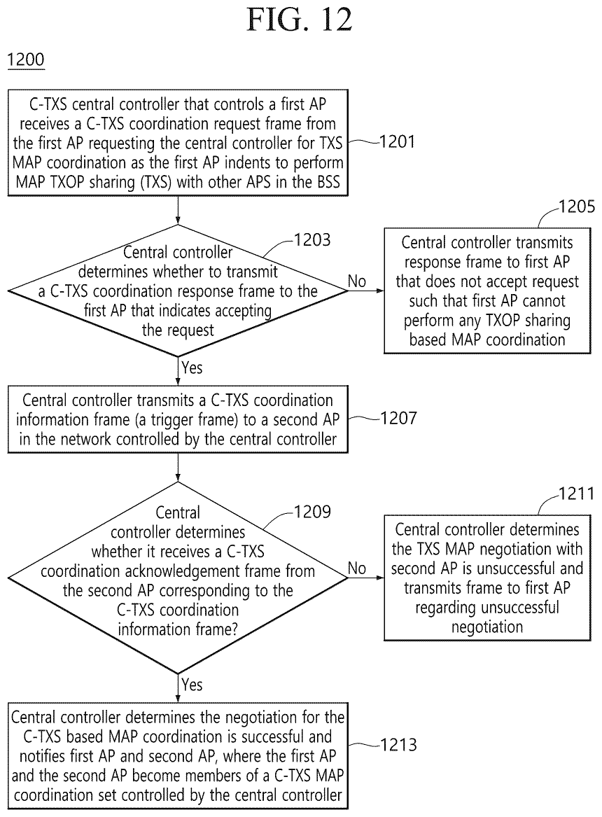

FIG. 12 illustrates a flow chart of an example process for MAP TXS negotiation of a type-II architecture in accordance with an embodiment. For explanatory and illustration purposes, the example process 1200 may be performed by the TXS central controller AP depicted in FIG. 10. Although one or more operations are described or shown in particular sequential order, in other embodiments the operations may be rearranged in a different order, which may include performance of multiple operations in at least partially overlapping time periods.

In operation 1201, the C-TXS central controller that controls a first AP receives a C-TXS coordination request frame from the first AP requesting the central controller for TXS MAP coordination as the first AP indents to perform MAP TXOP sharing (TXS) with other APS in the BSS.

In operation 1203, the central controller determines whether to transmit a C-TXS coordination response frame to the first AP that indicates accepting the request.

If the central controller determines not to transmit a C-TXS coordination response frame to the first AP that indicates accepting the request, in operation 1205 the central controller transmits response frame to first AP that does not accept request such that first AP cannot perform any TXOP sharing based MAP coordination.

If the central controller determines to transmit a C-TXS coordination response frame to the first AP that indicates accepting the request, in operation 1207 the central controller transmits a C-TXS coordination information frame (a trigger frame) to a second AP in the network controlled by the central controller.

In operation 1209, the central controller determines whether it receives a C-TXS coordination acknowledgement frame from the second AP corresponding to the C-TXS coordination information frame.

If the central controller determines that it has not received the C-TXS coordination acknowledgement frame from the second AP, in operation 1211, the central controller determines the TXS MAP negotiation with second AP is unsuccessful and transmits frame to first AP regarding unsuccessful negotiation.

If the central controller determines that it has received the C-TXS coordination acknowledgement frame from the second AP, in operation 1213, the central controller determines the negotiation for the C-TXS based MAP coordination is successful and notifies first AP and second AP, where the first AP and the second AP become members of a C-TXS MAP coordination set controlled by the central controller.

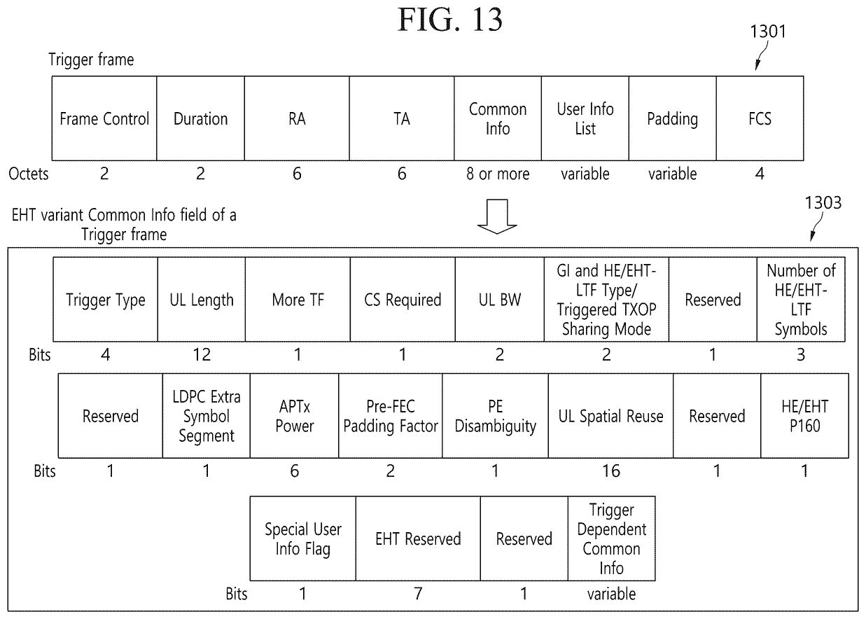

FIG. 13 illustrates an MU-RTS TXS frame in accordance with an embodiment. In particular, FIG. 13 illustrates an MU-RTS TXS trigger frame 1301 and an EHT variant Common Info field 1303 of the trigger frame. The MU-RTS TXS frame can include one or more fields, including, but not limited to, a frame control field, a duration field, a receiver address (RA) field, a transmitter address (TA) field, a Common Info field, a User Info List field, a Padding field, and a frame check sequence (FCS) field.

The Frame control field can include a value to indicate the type of frame. The Duration field may be set to the estimated time, in microseconds, required to transmit the pending frame(s). The Receiver Address (RA) field may include the address of the receiver of frame. The Transmitter Address (TA) field may include the address of the transmitter of the frame. The Common Info Field may indicate the MU-RTS TXS Mode and include one or more subfields, as described below. The User Info List may indicate a value of the bandwidth (BW) associated with the MU-RTS frame (and/or BW associated with the PPDU carrying the MU-RTS frame—for example, but not limited to, 320 MHz, 160+160 MHz, 240 MHz, 160+80 MHZ). The Padding field may be used for additional padding to compensate for different lengths of different MU-RTS frames. The FCS field is a frame check sequence for error-detection.

The EHT variant Common Info field 1303 of the trigger frame 1301 may include a Trigger Type field, a UL length field, a More Trigger Frame (TF) field, a Carrier Sense (CS) required field, an Up Link Bandwidth (UL BW) field, A DI and HE/E HT-LTF Type/Triggered TXOP Sharing Mode field, a Reserved Field, a Number of HE/EHT-LTF Symbols field, a Reserved field, a Low-Density Parity Check (LDPC) Extra Symbol Segment field, a AP transmitter (TX) power field, a Pre-FEC Padding Factor field, a PE Disambiguity field, a UL Spatial Rescue field, a Reserved field, an HE/EHT P160 filed, a Special User Info Flag field, a EHT Reserved field, a Reserved field, and a Trigger Dependent Common Info field.

The trigger type field may indicate a MU-RTS trigger frame. The UL Length field may signal a length of the expected response frame. The More TF field may indicate whether or not a subsequent trigger frame is scheduled for transmission. The CS Required field is set to 1 to indicate that the STAs identified in the User Info fields are required to use Energy Detect (ED) to sense the medium and to consider the medium state and the Network Allocation Vector (NAV) in determining whether or not to respond. The UL BW field (Up Link Bandwidth) indicates the bandwidth of the transmission. The GI and HE/EHT LTF Type/Triggered TXOP Sharing Mode field indicates the guard interval and long training field (GI and HE/EHT-LTF) type of the HE or EHT TB PPDU response, and the field may switch meaning between GI and HE/EHT-LTF type and triggered TXOP sharing mode fields based on the trigger type.

The Reserved field is reserved. The Number of HE/EHT LTF Symbols field indicates the number of HE-LTF symbols present in the HE TB PPDU or EHT-LTF symbols present in the EHT TB PPDU, respectively. The Reserved field is reserved. The LDPC Extra Symbol Segment field indicates the status of the LDPC extra symbol segment. The AP TX Power field provides the Tx Power used to transmit the frame. The Pre-FEC Padding Factor field indicates the pre-FEC padding factor. The PE Disambiguity field indicates the PE disambiguity. The UL Spatial Reuse field carries the values to be included in the Spatial Reuse fields in the HE-SIG-A field of the solicited HE TB PPDUs. The Reserved field is reserved. The HE/EHT P160 field may indicate whether the solicited TB PPDU in the primary 160 MHz is an EHT TB PPDU or an HE TB PPDU. The Special User Info Flag field may indicate that a Special User Info field is included in the Trigger frame that contains the EHT variant Common Info field. The EHT Reserved field is reserved. The Reserved field is reserved. The Trigger Dependent Common Info field is optionally present based on the value of the Trigger Type field.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

As described herein, any electronic device and/or portion thereof according to any example embodiment may include, be included in, and/or be implemented by one or more processors and/or a combination of processors. A processor is circuitry performing processing.

Processors can include processing circuitry, the processing circuitry may more particularly include, but is not limited to, a Central Processing Unit (CPU), an MPU, a System on Chip (SoC), an Integrated Circuit (IC) an Arithmetic Logic Unit (ALU), a Graphics Processing Unit (GPU), an Application Processor (AP), a Digital Signal Processor (DSP), a microcomputer, a Field Programmable Gate Array (FPGA) and programmable logic unit, a microprocessor, an Application Specific Integrated Circuit (ASIC), a neural Network Processing Unit (NPU), an Electronic Control Unit (ECU), an Image Signal Processor (ISP), and the like. In some example embodiments, the processing circuitry may include: a non-transitory computer readable storage device (e.g., memory) storing a program of instructions, such as a DRAM device; and a processor (e.g., a CPU) configured to execute a program of instructions to implement functions and/or methods performed by all or some of any apparatus, system, module, unit, controller, circuit, architecture, and/or portions thereof according to any example embodiment and/or any portion of any example embodiment. Instructions can be stored in a memory and/or divided among multiple memories.

Different processors can perform different functions and/or portions of functions. For example, a processor 1 can perform functions A and B and a processor 2 can perform a function C, or a processor 1 can perform part of a function A while a processor 2 can perform a remainder of function A, and perform functions B and C. Different processors can be dynamically configured to perform different processes. For example, at a first time, a processor 1 can perform a function A and at a second time, a processor 2 can perform the function A. Processors can be located on different processing circuitry (e.g., client-side processors and server-side processors, device-side processors and cloud-computing processors, among others).

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, the first AP comprising:
a memory;
a processor coupled to the memory, the processor configured to:
transmit a request frame requesting a transmission opportunity (TXOP) sharing to a plurality of APs including a second AP, wherein the request frame comprises a set of parameters for the TXOP sharing; and
receive a response frame from the second AP indicating the second AP accepts the TXOP sharing request.

2. The first AP of claim 1, wherein the processor is further configured to:
prior to transmitting the request frame, transmitting an announcement frame to the plurality of APs indicating an intention to initiate a multi-AP coordination; and
receive a preparedness frame from the second AP indicating capabilities to participate in the multi-AP coordination.

3. The first AP of claim 1, wherein the processor is further configured to:
receive a response frame from a third AP indicating that the third AP rejects the TXOP sharing request.

4. The first AP of claim 1, wherein the processor is further configured to:
receive a response frame from a third AP including an alternative set of parameters for the TXOP sharing; and
transmit another request frame to the third AP with the alternative set of parameters so that AP3 can participate in the TXOP sharing.

5. The first AP of claim 1, wherein the set of parameters specify rules regarding sharing the TXOP with other stations (STAs).

6. The first AP of claim 1, wherein the set of parameters including peer-to-peer (P2P) information related to the P2P stations (STAs) in a Basic Service Set (BSS) managed by the first AP.

7. The first AP of claim 6, wherein the set of parameters including P2P information related to the P2P STAs in a BSS managed by the second AP.

8. The first AP of claim 1, wherein the set of parameters include timing information on a portion of the TXOP that is allocated to the second AP.

9. The first AP of claim 1, wherein the set of parameters include channel information indicating a set of channels that the second AP is allowed to use.

10. The first AP of claim 1, wherein the set of parameters include operating class information indicating a set of operating classes that the second AP is allowed to use.

11. A first access point (AP) that serves as a central controller to coordinate transmission opportunity (TXOP) sharing in a wireless network, the first AP comprising:
a memory;
a processor coupled to the memory, the processor configured to:
receive a request frame requesting a transmission opportunity (TXOP) sharing from a second AP;
transmit a response frame to the second AP accepting the request for TXOP sharing request;
transmit a frame to a plurality of APs, including a third AP, with a set of parameters for the TXOP sharing; and
receive an acknowledgement frame from the third AP.

12. The first AP of claim 11, wherein the processor is further configured to:
prior to receiving the request frame, transmitting an announcement frame to the plurality of APs indicating an intention to initiate a multi-AP coordination; and
receive a preparedness frame from the third AP indicating capabilities to participate in the multi-AP coordination.

13. The first AP of claim 11, wherein the processor is further configured to:
receive a response frame from a fourth AP indicating that the fourth AP rejects the TXOP sharing request.

14. The first AP of claim 11, wherein the processor is further configured to:
receive a response frame from a fourth AP including an alternative set of parameters for the TXOP sharing; and
transmit another request frame to the fourth AP with the alternative set of parameters so that AP3 can participate in the TXOP sharing.

15. The first AP of claim 11, wherein the set of parameters specify rules regarding sharing the TXOP with other stations (STAs).

16. The first AP of claim 11, wherein the set of parameters including peer-to-peer (P2P) information related to the P2P stations (STAs) in a Basic Service Set (BSS) managed by the second AP.

17. The first AP of claim 16, wherein the set of parameters including P2P information related to the P2P STAs in a BSS managed by the third AP.

18. The first AP of claim 11, wherein the set of parameters include timing information on a portion of the TXOP that is allocated to the third AP.

19. The first AP of claim 11, wherein the set of parameters include channel information indicating a set of channels that the third AP is allowed to use.

20. The first AP of claim 11, wherein the parameters include operating class information indicating a set of operating classes that the third AP is allowed to use.
